(19) United States
(12) Patent Application Publication
(10) Pub. No.: US 2010/0203420 A1
(43) Pub. Date: Aug. 12, 2010

(54) FUEL CELL ELECTRODE CATALYST, METHOD FOR EVALUATING PERFORMANCE OF OXYGEN-REDUCING CATALYST, AND SOLID POLYMER FUEL CELL COMPRISING THE FUEL CELL ELECTRODE CATALYST

(75) Inventors: Yukiyoshi Ueno, Shizuoka (JP); Hirofumi Iisaka, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOYOTA JIDOSHA KABUSHIKI KAISHA, Aichi (JP)

(21) Appl. No.: 12/669,599

(22) PCT Filed: Jul. 23, 2008
(86) PCT No.: PCT/JP2008/063615

§ 371 Date: Jan. 19, 2010

(30) Foreign Application Priority Data
Jul. 24, 2007 (JP) 2007-192443

(51) Int. Cl. H01M 8/10; B01J 27/045; H01M 4/88

(52) U.S. Cl. 429/484; 502/223; 502/101

(57) ABSTRACT

According to the present invention, a fuel cell electrode catalyst comprising a transition metal element and a chalcogen element and having high activity is provided with an index for performance evaluation that is useful for good catalyst design. Also, a fuel cell electrode catalyst is provided, such catalyst comprising at least one transition metal element and at least one chalcogen element, wherein the value of (transition metal element−chalcogen element coordination number)/(transition metal element−transition metal element coordination number) is 0.9 to 2.5.

### TECHNICAL FIELD

The present invention relates to a fuel cell electrode catalyst comprising at least one transition metal element and at least one chalcogen element, which can replace a conventional platinum catalyst, a method for evaluating performance of an oxygen-reducing catalyst, and a solid polymer fuel cell comprising such fuel cell electrode catalyst.

### BACKGROUND ART

Anode catalysts used for polymer electrolyte fuel cells are mainly platinum and platinum-alloy-based catalysts. Specifically, catalysts in which a platinum-containing noble metal is supported by carbon black have been used. In terms of practical applications of polymer electrolyte fuel cells, one problem relates to the cost of materials. A means to solve such problem involves reduction in the platinum content.

Meanwhile, it has been known that when oxygen (O₂) is electrolytically reduced, superoxide is generated as a result of one-electron reduction, hydrogen peroxide is generated as a result of two-electron reduction, or water is generated as a result of four-electron reduction. When voltage reduction occurs for some reason in a fuel cell stack using, as an electrode, a platinum or platinum-based catalyst, four-electron reduction performance deteriorates, resulting in two-electron reduction. Accordingly, hydrogen peroxide is generated, causing MEA deterioration.

Recently, low-cost fuel cell catalysts have been developed via a reaction that produces water as a result of four-electron reduction of oxygen, which will result in elimination of the need for expensive platinum catalysts. Non-Patent Document 1 described below discloses that a catalyst comprising a chalcogen element is excellent in terms of four-electron reduction performance and suggests that such catalyst be applied to fuel cells.

Likewise, Patent Document 1 described below discloses, as a platinum (Pt) catalyst substitute, an electrode catalyst comprising at least one transition metal and a chalcogen. An example of a transition metal is Ru and an example of a chalcogen is S or Se. It is also disclosed that, in such case, the Ru:Se molar ratio is from 0.5:1 to 2:1 and the stoichiometric number “n” of (Ru)nSe is 1.5 to 2.

Further, Patent Document 2 described below discloses, as a Pt catalyst substitute, a fuel cell catalyst material comprising a transition metal that is either Fe or Ru, an organic transition metal complex containing nitrogen, and a chalcogen component such as S.

In addition, Non-Patent Document 1 described below discloses an Mo—Ru—Se ternary electrode catalyst and a method for synthesizing the same.

Further, Non-Patent Document 2 described below discloses Ru—S, Mo—S, and Mo—Ru—S binary and ternary electrode catalysts and methods for synthesizing the same.

Furthermore, Non-Patent Document 3 described below discloses Ru—Mo—S and Ru—Mo—Se ternary chalcogenide electrode catalysts.

Patent Document 1: JP Patent Publication (Kohyo) No. 2001-502467 A

Patent Document 2: JP Patent Publication (Kohyo) No. 2004-532734 A

Non-Patent Document 1: Electrochimica Acta, vol. 39, No. 11/12, pp. 1647-1653, 1994

Non-Patent Document 2: J. Chem. Soc., Faraday Trans., 1996, 92 (21), 4311-4319

Non-Patent Document 3: Electrochimica Acta, vol. 45, pp. 4237-4250, 2000

### DISCLOSURE OF THE INVENTION

### Problem to be Solved by the Invention

The catalysts disclosed in Patent Document 1 and Non-Patent Documents 1, 2, and 3 are insufficient in terms of four-electron reduction performance. Therefore, the development of high-performance catalysts and of an index for performance evaluation that is useful for high-performance catalyst design has been awaited.

### Means for Solving Problem

The present inventors have found that, in the case of a fuel cell electrode catalyst comprising a transition metal element and a chalcogen element, the ratio of the coordination number of one element to that of the other is closely related to the oxygen reduction performance of such catalyst. Further, they have found that the above problem can be solved by designating the coordination number ratio as an index for performance evaluation that is useful for catalyst design. This has led to the completion of the present invention.

Specifically, in a first aspect, the present invention relates to a fuel cell electrode catalyst comprising at least one transition metal element and at least one chalcogen element, characterized in that the value of (transition metal element-chalcogen element coordination number)/(transition metal element-transition metal element coordination number) is 0.9 to 2.5.

Herein, the “transition metal element−chalcogen element coordination number” and the “transition metal element−transition metal element coordination number” of an electrode catalyst are determined not only based on the composition ratio of a transition metal element to a chalcogen element but also based on the nature of a crystal of catalyst particles comprising both elements, the particle size thereof, and the like. In addition, it is possible to change crystallographic activity, particle-size-dependent activity, and the like of such catalyst particles mainly based on conditions of baking after catalyst preparation.

Regarding the fuel cell electrode catalyst of the present invention, which comprises at least one transition metal element and at least one chalcogen element, it is preferable that a transition metal element be at least one selected from the group consisting of ruthenium (Ru), molybdenum (Mo), osmium (Os), cobalt (Co), rhodium (Rh), iridium (Ir), iron (Fe), nickel (Ni), titanium (Ti), tungsten (W), palladium (Pd), and rhenium (Re), and that a chalcogen element be at least one selected from the group consisting of sulfur (S), selenium (Se), and tellurium (Te).

In a second aspect, the present invention relates to a method for evaluating performance of an oxygen-reducing catalyst represented by a fuel cell electrode catalyst, characterized in that the value of (transition metal element-chalcogen element coordination number)/(transition metal element−transition metal element coordination number) is used as an index of catalyst performance for a fuel cell electrode catalyst comprising at least one transition metal element and at least one chalcogen element. Accordingly, such method is useful in the design of an excellent oxygen-reducing catalyst.

Specifically, an oxygen-reducing catalyst can receive an excellent evaluation when the value of (transition metal element−chalcogen element coordination number)/(transition metal element−transition metal element coordination number) is 0.9 to 2.5.

As described above, it is preferable that the above transition metal element be at least one selected from the group consisting of ruthenium (Ru), molybdenum (Mo), osmium (Os), cobalt (Co), rhodium (Rh), iridium (Ir), iron (Fe), nickel (Ni), titanium (Ti), tungsten (W), palladium (Pd), and rhenium (Re), and that the above chalcogen element be at least one selected from the group consisting of sulfur (S), selenium (Se), and tellurium (Te).

In a third aspect, the present invention relates to a solid polymer fuel cell comprising the above fuel cell electrode catalyst.

### EFFECTS OF THE INVENTION

The fuel cell electrode catalyst of the present invention has a higher level of four-electron reduction performance and higher activity than a conventional transition metal-chalcogen element-based catalyst, and thus it can serve as a platinum catalyst substitute.

In addition, the technique for obtaining the value of (transition metal element-chalcogen element coordination number)/(transition metal element-transition metal element coordination number) used in the present invention is widely useful in the design of oxygen-reducing catalysts.

### BRIEF DESCRIPTION OF THE DRAWINGS

FIG. 1 shows structural analysis results for Ru-containing chalcogenide obtained via EXAFS.

FIGS. 2A, 2B, 2C show TEM images (FIGS. 2A, 2B) of an Ru—S portion of Ru-containing chalcogenide obtained via TEM and an X-ray diffraction image (FIG. 2C) of the Ru—S portion.

FIGS. 3A, 3B, 3C show TEM images (FIGS. 3A, 3B) of an Ru—Ru portion of Ru-containing chalcogenide obtained via TEM and an X-ray diffraction image (FIG. 3C) of the Ru—Ru portion.

FIG. 4 shows structural analysis results for Ru-containing chalcogenide (sulfur content: 20%) obtained via EXAFS.

FIG. 5 shows structural analysis results for Ru-containing chalcogenide (sulfur content: 45%) obtained via EXAFS.

FIG. 6 shows structural analysis results for Ru-containing chalcogenide (sulfur content: 71%) obtained via EXAFS.

FIG. 7 shows results obtained by a rotating ring-disk electrode (RDE) evaluation method whereby the above catalyst materials having different sulfur contents were evaluated in relation to the oxygen reduction performance of Ru-containing chalcogenide.

FIG. 8 shows the correlation between the value of Ru sulphide (Ru—S)/Ru metal component (Ru—Ru) and the oxygen reduction current value.

### BEST MODE FOR CARRYING OUT THE INVENTION

Hereinafter, the present invention is described in more detail with reference to the Examples and the Comparative Examples.

### [Catalyst Preparation]

Ruthenium carbonyl, molybdenum carbonyl, and sulfur were heated at 140° C. in the presence of argon, followed by cooling. Thereafter, the resultant was washed with acetone and filtered. The obtained filtrate containing RuMoS/C (Ru:Mo:S=5:1:5; 60 wt %) was baked at 350° C. for 2 hours. Thus, a catalyst was prepared.

### [Structural Analysis]

The above catalyst material was subjected to structural analysis via EXAFS and TEM.

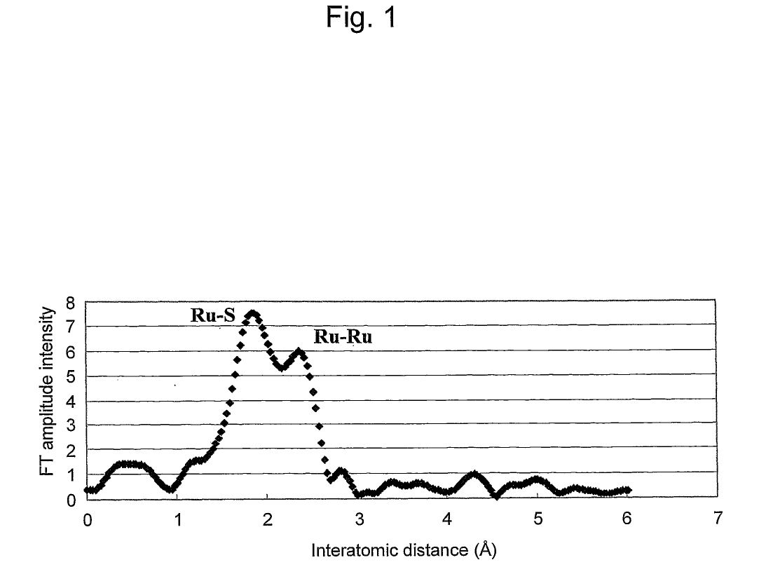

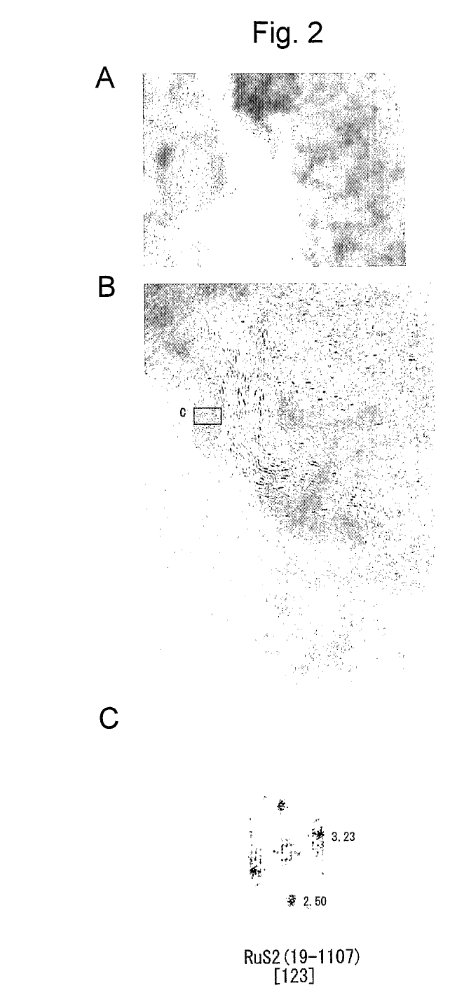

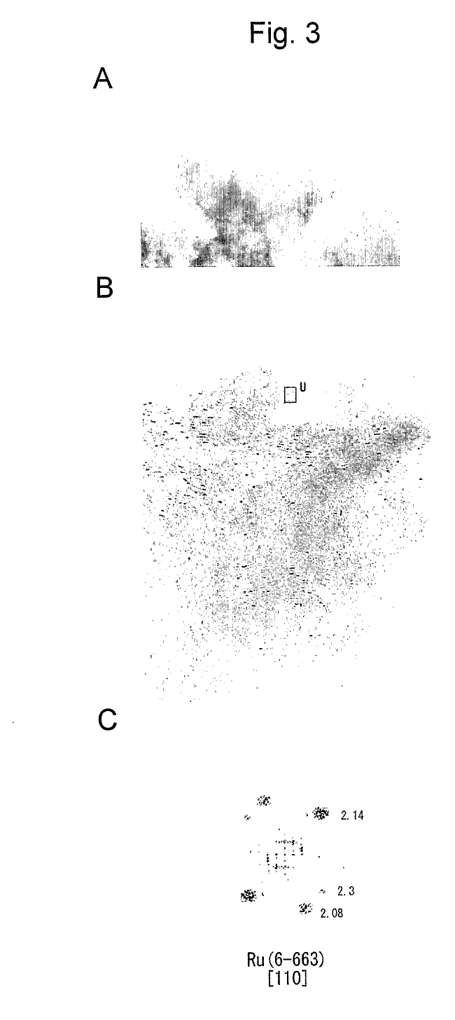

FIG. 1 shows structural analysis results for Ru-containing chalcogenide obtained via EXAFS (extend X-ray absorption fine structure). FIGS. 2A, 2B, 2C show TEM images (FIGS. 2A, 2B) of an Ru—S portion in Ru-containing chalcogenide obtained via TEM and an X-ray diffraction image (FIG. 2C) of the Ru—S portion. Likewise, FIGS. 3A, 3B, 3C show TEM images (FIGS. 3A, 3B) of an Ru—Ru portion of Ru-containing chalcogenide obtained via TEM and an X-ray diffraction image (FIG. 3C) of the Ru—Ru portion.

As a result of structural analysis via EXAFS and TEM, Ru-containing chalcogenide was found to comprise an Ru sulphide (Ru—S) and an Ru metal component (Ru—Ru).

[Structural Analysis and Performance Evaluation of Catalyst Materials with Different S Contents]

Catalyst materials were prepared in the same manner as that described above, provided that each material had a different sulfur content (0, 20, 45, or 71 mol %).

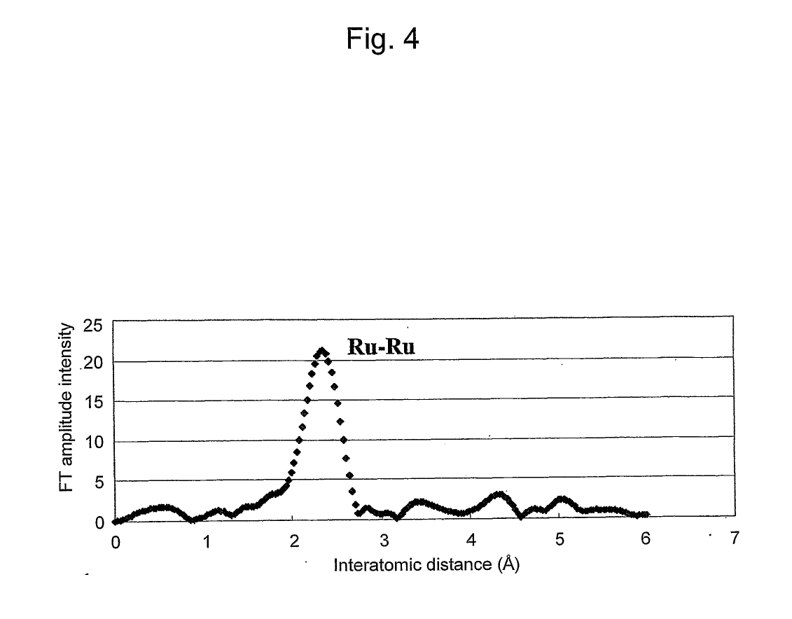

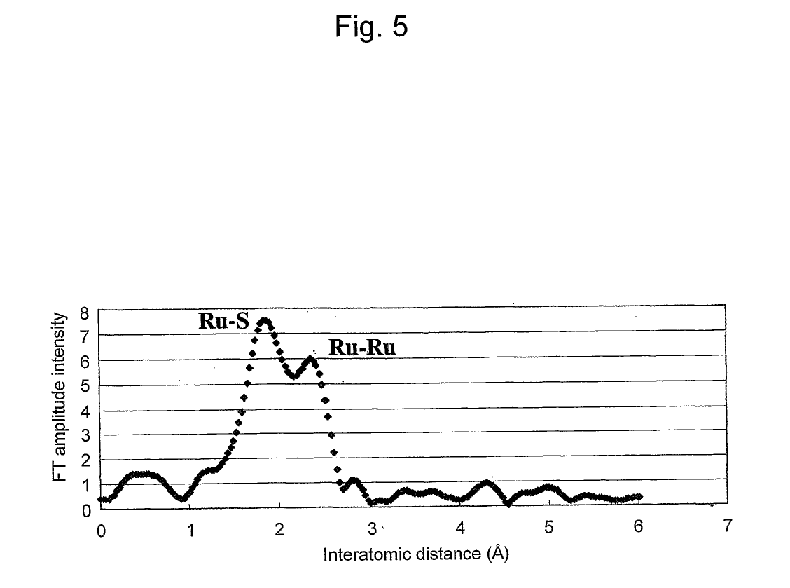

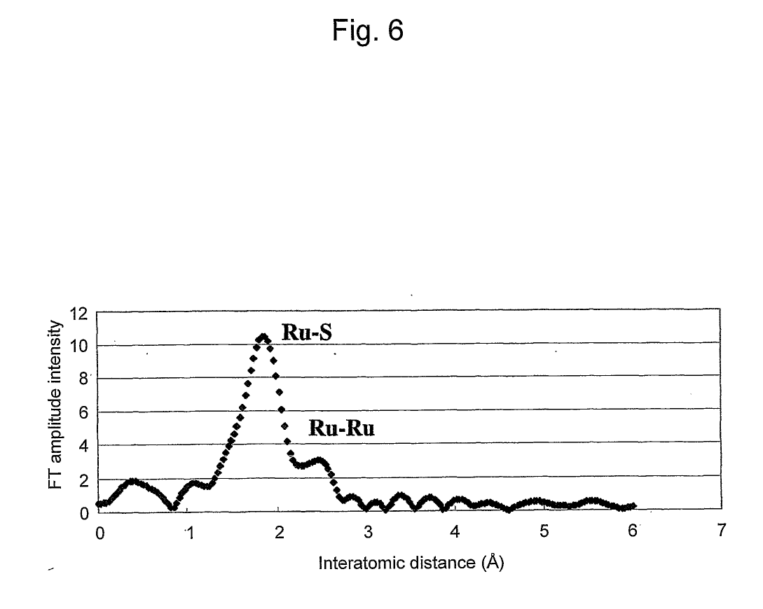

FIG. 4 shows structural analysis results for Ru-containing chalcogenide (sulfur content: 20%) obtained via EXAFS. The results of FIG. 4 indicate the exclusive presence of Ru—Ru bonds. FIG. 5 shows structural analysis results for Ru-containing chalcogenide (sulfur content: 45%) obtained via EXAFS. The results of FIG. 5 indicate the presence of Ru—S bonds and of Ru—Ru bonds. FIG. 6 shows structural analysis results for Ru-containing chalcogenide (sulfur content: 71%) obtained via EXAFS. The results of FIG. 6 indicate the presence of many Ru—S bonds and of a small number of Ru—Ru bonds.

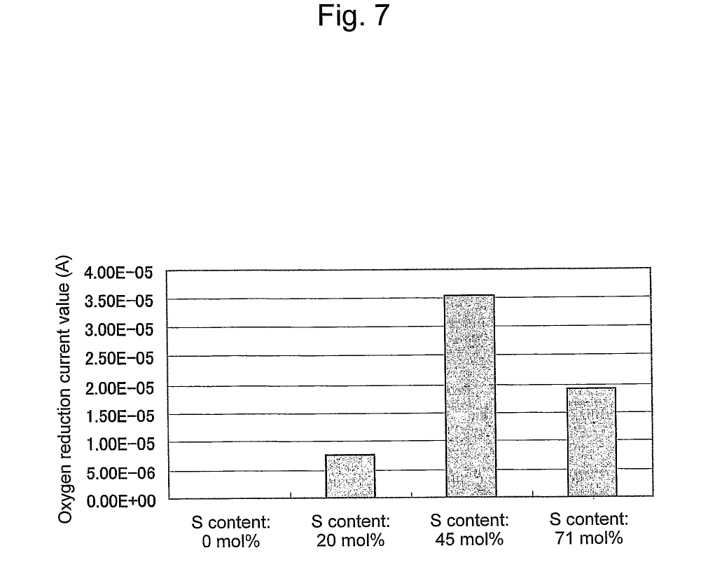

FIG. 7 shows results obtained by a rotating disk electrode (RDE) evaluation method whereby the above catalyst materials having different sulfur contents were evaluated in relation to the oxygen reduction performance of Ru-containing chalcogenide.

The correlation between the following factors was examined: the proportion of the coordination number of the Ru sulphide (Ru—S) to that of the Ru metal component (Ru—Ru) obtained from FIGS. 4 to 6; and the results of oxygen reduction performance evaluation obtained from FIG. 7. Herein; regarding the Ru sulphide (Ru—S) and the Ru metal component (Ru—Ru), Fourier transform amplitudes of Ru—S bonds and Ru—Ru bonds shown in FIGS. 4 to 6 were calculated to derive the coordination numbers thereof.

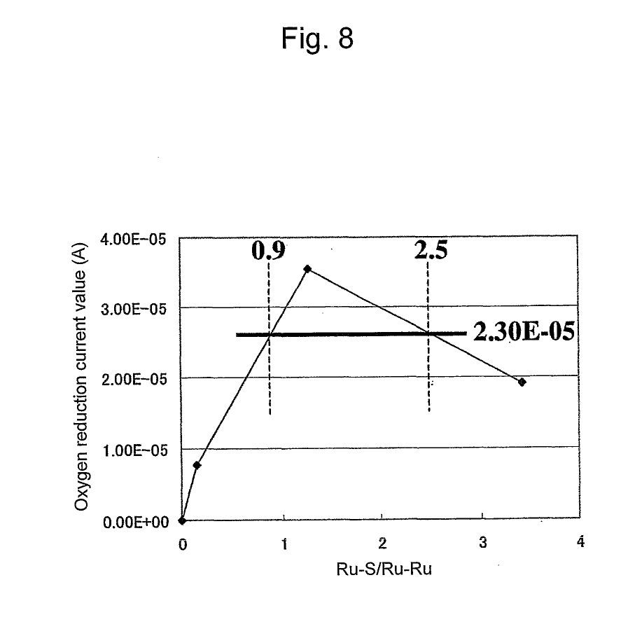

FIG. 8 shows the correlation between the value of Ru sulphide (Ru—S)/Ru metal component (Ru—Ru) and the oxygen reduction current value. Based on the results shown in FIG. 8, it is understood that an excellent oxygen-reducing catalyst is obtained when the value of (transition metal element-chalcogen element coordination number)/(transition metal element−transition metal element coordination number) is 0.9 to 2.5.

### INDUSTRIAL APPLICABILITY

The fuel cell electrode catalyst of the present invention has a high level of four-electron reduction performance and high activity, and thus it can serve as a platinum catalyst substitute. In addition, the technique for obtaining the value of (transition metal element−chalcogen element coordination number)/(transition metal element−transition metal element coordination number) used in the present invention is widely useful in the design of oxygen-reducing catalysts. Therefore, the present invention contributes to the practical and widespread use of fuel cells.

1. A fuel cell electrode catalyst comprising ruthenium and sulfur, wherein the value of (ruthenium-sulfur coordination number)/(ruthenium-ruthenium coordination number) is 0.9 to 2.5.

2. (canceled)

3. (canceled)

4. (canceled)

5. (canceled)

6. A solid polymer fuel cell, which comprises the fuel cell electrode catalyst according to claim 1.

7. A method for manufacturing a fuel cell electrode catalyst comprising ruthenium and sulfur which comprises a step of selecting a composition of the catalyst so as to adjust the value of (ruthenium-sulfur coordination number)/(ruthenium-ruthenium coordination number) in the range of 0.9 to 2.5.
